(19) United States
(12) Patent Application Publication
(10) Pub. No.: US 2009/0302015 A1
(43) Pub. Date: Dec. 10, 2009

(54) Checkcard-Type Remote Controller With Electrode Contacts for Increasing and Reducing a Welding Parameter, and with a Readout

(75) Inventors: Thomas Feitzlmaier, Wilhering (AT); Thomas Knoll, Traun (AT)

Correspondence Address: COLLARD & ROE, P.C., 1077 NORTHERN BOULEVARD, ROSLYN, NY, 11576, US

(73) Assignee: FRONIUS INTERNATIONAL GMBH, Pettenbach (AT)

(21) Appl. No.: 12/227,535

(22) PCT Filed: Mar. 21, 2007
(86) PCT No.: PCT/AT2007/000134

§ 371 Date: Nov. 20, 2008

(30) Foreign Application Priority Data
May 26, 2006 (AT) A 911/2006

(51) Int. Cl. B23K 9/10; B23K 9/00

(52) U.S. Cl. 219/132; 219/136

(57) ABSTRACT

The invention relates to a remote controller for a welding device (1) with a housing, a control unit (33) and several contact elements (27), wherein one contact element (27) is comprised of a workpiece contact (30) for establishing a connection with a workpiece (16), and wherein at least two further contact elements are comprised of electrode contacts (28, 32) for establishing a connection with an electrode (13) of the welding device (1), wherein the one electrode contact (28, 32) is designed for increasing the value of a welding parameter and the second electrode contact (28) is designed for reducing the same, the value of the welding parameter thus being changeable by contacting the electrode contacts (28, 32) with the electrode (13) of the welding device. In order to create such a remote controller which is particularly cost-effective in terms of production and provides improved handling, it is provided that a voltage supply is effected by the welding device via the contact elements (27), and that the control unit (33) is connected with a readout designed for visualization of the value and/or type of the welding parameter to be changed.

The invention relates to a remote controller for a welding device with a housing and/or a protective sleeve, a control unit and several contact elements connected with the control unit, wherein one contact element is comprised of a workpiece contact for establishing a connection with a workpiece, and wherein at least two further contact elements are comprised of electrode contacts for establishing a connection with an electrode of the welding device, wherein the one electrode contact is designed for increasing the value of a welding parameter and the second electrode contact is designed for reducing the same, the value of the welding parameter thus being changeable by contacting the electrode contacts with the electrode of the welding device.

From U.S. Pat. No. 6,040,555 A, a remote controller of the present kind is known which allows for the welding device to be turned on/off as well as to be ignited, and for the welding parameters to be changed at the location of the welding torch remote from the welding device. To this end, the remote controller has several contact elements which are connected with corresponding electronic switching circuits, which, upon contacting the contact element, send a corresponding control signal to the welding device. A battery is necessary for operating the electronic switching circuits and for generating the control signals. This is why the remote controller is relatively large.

DE 33 29 216 A1 shows a wireless remote controller for a welding device with at least two contacts, the one of which being designed for contacting the workpiece and the other one for contacting the welding electrode. Depending on the contacting order, a signal with a corresponding frequency is generated and superimposed on the welding current, thus allowing for an increase or reduction of the welding parameter to be achieved.

A remote controller for setting parameters for a welding device is known from EP 0 575 082 A2, wherein the communication between the remote controller and the current source and/or an auxiliary device of the welding device is effected in wire-bound manner or via radio signals in a wireless manner. Here, the wire-bound signal transmission is effected via the welding cable, which is inductively or capacitively coupled with a transmitter and a receiver for radio signals, thus allowing for information formation to be transmitted between the remote controller and the current source and/or the auxiliary device of the welding device in a unidirectional or bidirectional manner.

Accordingly, EP 0 575 082 A2 discloses a device and a method which enables the signal and/or data transmission between a remote controller and a current source of a welding device via the welding cable of the welding device.

Such or similar methods for signal transmission via welding cables and correspondingly designed remote controllers are sufficiently known from the prior art. Here, an electric contact is provided on the remote controller, to which the current-carrying welding electrode of the welding torch can be applied, wherein a control unit of the welding device will recognize the remote controller as such. For the purpose of changing parameters of the welding device, these known remote controllers have one or several setting means, e.g. analogue control dials and/or potentiometers, sampling units or touch-sensitive foils, which are to be manually operated by a user. Such remote controllers involve the drawback that the used setting means cause high component costs, and that the remote controller is also expensive to produce due to high production expenditure. Furthermore, the size of the components for the setting means delimits the compactness of these remote controllers, and these remote controllers are difficult to handle and transport. The manual setting via setting means involves great time effort for a user, in particular in case of settings between the different welding processes to be done frequently or of parameters to be frequently corrected.

A remote controller and an operation unit for a welding device are known from WO 03/022503 A1, wherein a menu-guided setting is possible for the most different parameters of a welding device. Due to the interfaces and setting means present, this remote controller is of a large structure, which has negative effects on handling and transporting. Furthermore, the remote controller is only little robust because of the many components necessary and is expensive to produce.

The object of the present invention resides in reducing the production costs of a remote controller for a welding device. One object of the invention resides in improving the handling of a remote controller. One further object of the remote controller is to improve the robustness and prolong service life of a remote controller.

The inventive object is achieved in that a voltage supply is effected by the welding device via the contact elements, and that the control unit is connected with a readout designed for visualization of the value and/or type of the welding parameter to be changed. Here, it is advantageous the the remote controller does not have any setting means, such as potentiometer or incremental encoder, but that the desired values are adjusted directly via the electrode contacts. This allows for the production costs of the remote controller to be substantially reduced since the printed circuit board may be placed for production in a completely automated manner. By contrast, known remote controllers with setting means have to be structured and/or assembled manually or with complex operation steps. A further advantage is that, upon an electrode contact contacting the electrode of the welding device, the remote controller will be supplied with voltage, and, thereafter, an action and/or a function call, e.g. the change of a welding parameter, will be triggered immediately. The electrode contact, in addition to this executable action, also allows for the energy supply of the remote controller. Thereby, a better handling of the remote controller is achieved since the user may do an adjustment simply by correspondingly contacting the electrode with the electrode contact, and the user does not have to put the welding torch away for doing an adjustment via the remote controller. With known remote controllers having setting means, the user has to contact the remote controller with the electrode and, at the same time, has to actuate the setting means. Furthermore, the inventive remote controllers do not require any moveable parts for realizing a fully functional remote controller, thus creating a remote controller which is robust and little susceptible to errors. This structure allows for the remote controller to be very small, e.g. to be designed to have the size of a checkcard. By the measure that the control unit is connected with a readout (and/or with displaying means), which is designed for visualization of the value and/or the type of the welding parameter to be changed, the user can see the value and/or type of the welding parameter at any time and, at the same time, can observe the adjustment process, and can thus set the welding device exactly.

If is advantageous if the control unit has a storage, in which at least the welding parameter which has lastly been adjusted or called via one of the at least two electrode contacts is deposited. Thus, the lastly set and/or lastly processed value, e.g. a value of a welding parameter and/or the type of the welding parameter, may simply be reused for further processing, e.g. for displaying at the displaying means. Furthermore, the user may immediately use a stored value for configuration of the welding device when changing the welding device, and the user does not have to again set a value via the contact elements. The welder can send their preset values quickly to the welding device in a simple manner, irrespective of the welding device.

Advantageously, the control unit is designed for outputting a signal which has been detected as a function of the value of an applying and/or adjusted welding parameter and which has particularly been calculated, wherein the signal is applied to at least one contact element for the electrode. Thus, the value detected by the control unit and/or a signal generated therefrom can be sensed via one of the electrode contacts and this signal and the information contained therein may be sent to the control unit and/or current source of the welding device via the electrode in a simple manner.

If the readout is designed for displaying a proportional, in particular percentual, value of a welding parameter, the setting of a value may be effected by a user in a very intuitive manner, and the number of display sites of the displaying means may be optionally enabled by graduation in percentual steps, thus allowing for a small structure of the remote controller.

The readout may be comprised of a display or scale-forming illumination means, in particular LEDs, thus creating a cost-effective and convenient display unit.

According to a further feature of the invention, the control unit may by connected with a readout (and/or displaying means) for displaying a present contact of the contact elements with the electrode and the workpiece. Thus, a user may immediately check the operational state and/or a correct starting-up of the remote controller.

Furthermore, the control unit may be connected with a readout for displaying the polarity prevailing at the contact element connected with the electrode, whereby the polarity prevailing and/or set on the electrode of the welding parameter can be advantageously read from the remote controller.

If the control unit comprises a voltage supply, in particular a power electronics for voltage conversion of the idle voltage of the welding device into an appropriate voltage for supplying the components of the control unit, the components of the remote controller may be supplied via the welding device.

According to a further feature of the invention, it is provided that the control unit comprises a logic circuit, in particular a microcontroller. The voltage supply converts the idle voltage of a welding device into an appropriate voltage for the components of the remote controller, in particular the logic circuit. Thus, there is no need for a permanent energy storage in the remote controller since the remote controller is supplied with energy via the welding device. Thus, the remote controller can be implemented to be of very small size and, at the same time, the costs may also be reduced. Furthermore, this allows for the remote controller to be constantly ready-for-use and maintenance-free.

Particularly if a microcontroller is used, the remote controller can be programmed in a simple manner and, at the same time, components can be omitted, thus reducing the weight and size of the remote controller. A state at the output of the control unit and/or the remote controller may be determined via the logic circuit in an advantageous manner as a function of the signals applying to the contact elements.

In one embodiment variant in which the control unit comprises a switching element for generating a preferably high-frequency modulation signal for coupling into the idle voltage of the electrode, information may be transmitted from the remote controller to the welding device via the modulated idle voltage of the welding device. The control unit of the welding device has a corresponding device for evaluating and/or demodulating the idle voltage. Thus, the setting done can be transmitted to the control unit of the welding device via the electrode and/or the welding lines of the welding device without the need of further transmitting and receiving means being provided on the remote controller.

A particularly suited and simple unit for generating a modulation frequency by a remote controller is particularly allowed for by the measure that the switching element is connected with an output of the logic circuit at a control input and is furthermore connected with the voltage supply, and that an output of the switching element is coupled with at least one of the contact elements.

A design is also of advantage in which the control unit comprises a delay member, whereby the stored value of a welding parameter will be displayed with a predefined period of time when the electrode contacts one of the contact elements, wherein the value or the type of the welding parameter will be adjustable after the period has expired. Thus, a contact element can fulfil several functions, e.g. displaying the present value and adjusting the value of a welding parameter. Here, the stored and/or present parameter value can be displayed by the welder shortly contacting the contact element with the electrode, on the one hand, and the welder can introduce the adjustment by a longer contact such that the stored value will be increased or reduced, depending on which electrode contact the welder contacts with the electrode, wherein the parameter value changed may be transmitted to the welding device at the same time, i.e. online, on the other hand.

By the measure that the workpiece contact for contacting a workpiece is arranged on the rear side of the housing and that the workpiece contact is preferably designed to be magnetic, a good contact to the workpiece can be established by simply putting the remote controller on the workpiece, with no need for a user to leave their working place in the region of the workpiece. The magnetic design of the workpiece contact allows for the remote controller to be discretely held at the workpiece, thus facilitating its operation.

If the housing is designed in a substantially checkcard-type manner, the very compact dimensions of the remote controller enable a very handy design of the same, due to which the welder can transport the remote controller in a simple manner by simply putting the same in their pocket.

In a particularly advantageous embodiment variant, the housing has a width of from 20 to 100 mm, in particular of from 40 to 70 mm, a length of from 50 to 150 mm, in particular of from 60 to 120 mm, and a thickness of from 5 to 30 mm, in particular of from 10 to 20 mm.

The housing may be designed to be at least partially transparent.

The control unit, and optionally the readouts may be integrated, and in particular molded, into the housing, wherein only the contact surfaces of the contact elements are accessible from the outside. Thus, components, such as the readouts, may be completely enclosed by the housing, e.g. molded thereinto, resulting in a very robust and compact design of the housing. The user can look at the readouts provided below the transparent part of the housing. Furthermore, no inspection windows or the like are necessary, thus minimizing the production costs of the remote controller. Moreover, the sensitive components of the remote controller are protected from dirt and dust, and, at the same time, particularly by the molding-in, the components are very well protected from shocks and no liquid can penetrate into the interior of the remote controller.

By the measure that a further contact element is comprised of a third electrode contact, wherein the first electrode contact is designed for displaying the value and/or the type of a welding parameter to be adjusted, whereas the two further electrode contacts are designed for adjusting the value of the welding parameter, in particular for increasing and/or reducing the value of the welding parameter, it is advantageously achieved that a very simple operation of the remote controller is provided to the welder since a specific task has been allocated to each electrode contact. Thereby, a quick adjustment of the remote controller is also enabled and, when changing the welding device, the value stored can be transmitted to the new welding device in a simple manner by the welder just contacting the electrode contact for the displaying function.

In a further embodiment variant, at least one further contact element is comprised of an electrode contact which is designed for selecting a welding parameter. Here, it is advantageous that the welder may select further types of welding parameters to be adjusted using the additional electrode contact, wherein the welding parameters are switched through, particularly in a cyclical manner. Thus, it can, e.g., be switched between the types of parameters current, voltage, pulse width, frequency, and the like. Thereby, it is possible in a simple manner to successively call several adjustable welding parameters via this electrode contact. In the case of several additional electrode contacts, they may also be designed such that a fixed welding parameter is assigned to each electrode contact. Likewise, it is possible, in the case of two further electrode contacts, to design the same for different direction-switches so as to allow for the individual welding parameters to be called successively.

By the measure that the control unit has a safety system for blocking or deblocking the welding device in a preferably wireless manner, the remote controller may additionally be used as key for putting into operation a welding device, thus advantageously preventing the welding device from being used by non-authorized personnel.

In an advantageous further design, the safety system is comprised of a radio-transmission system, in particular an RFID system. Accordingly, the remote controller has a unique identification characteristic. The use of an RFID system and/or a transponder is advantageous since these components enable a wireless use of the remote controller, thus not restricting operation and wear comfort of the remote controller.

The present invention will be explained in more detail by means of the enclosed schematic drawings.

Therein:

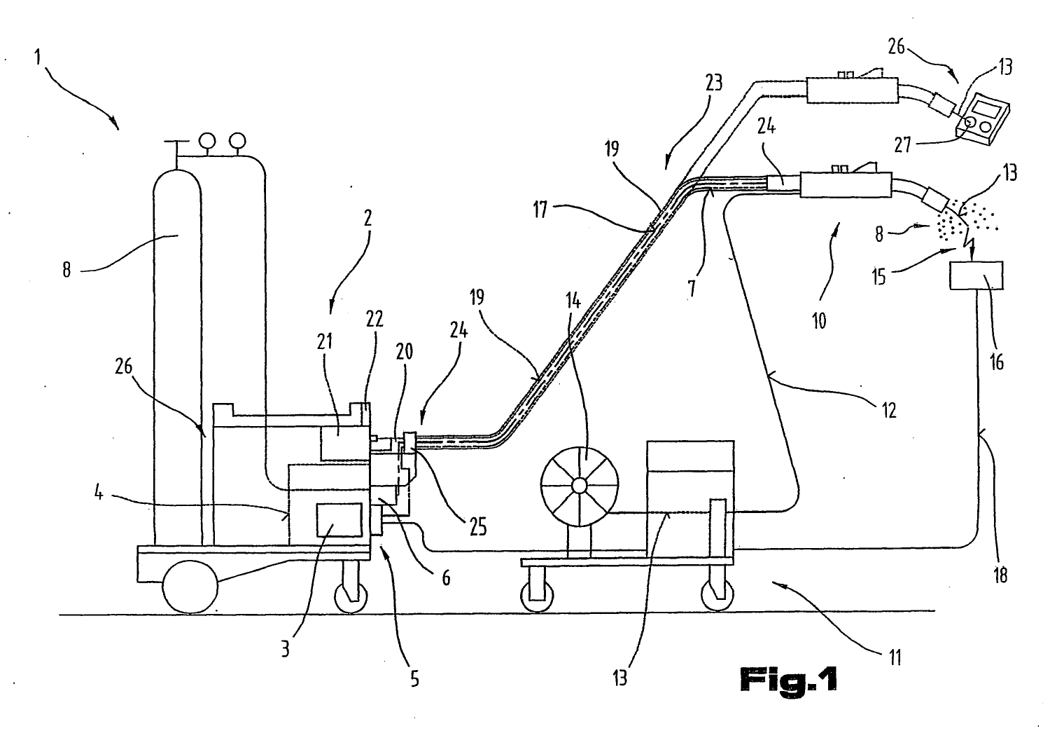

FIG. 1 shows the inventive remote controller for a welding device, together with an exemplary embodiment variant of a welding device in a schematic side view;

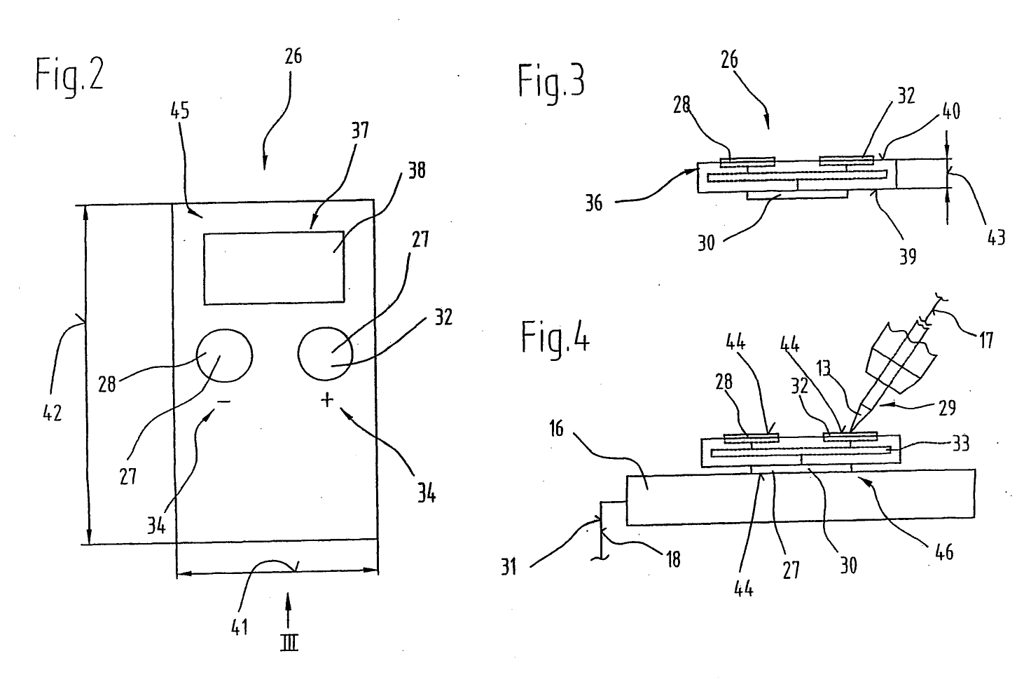

FIG. 2 shows an embodiment variant of the remote controller in a top view;

FIG. 3 shows the remote controller of FIG. 2 in a side view according to arrow III in FIG. 2;

FIG. 4 shows the remote controller of FIG. 2 in operation in a side view;

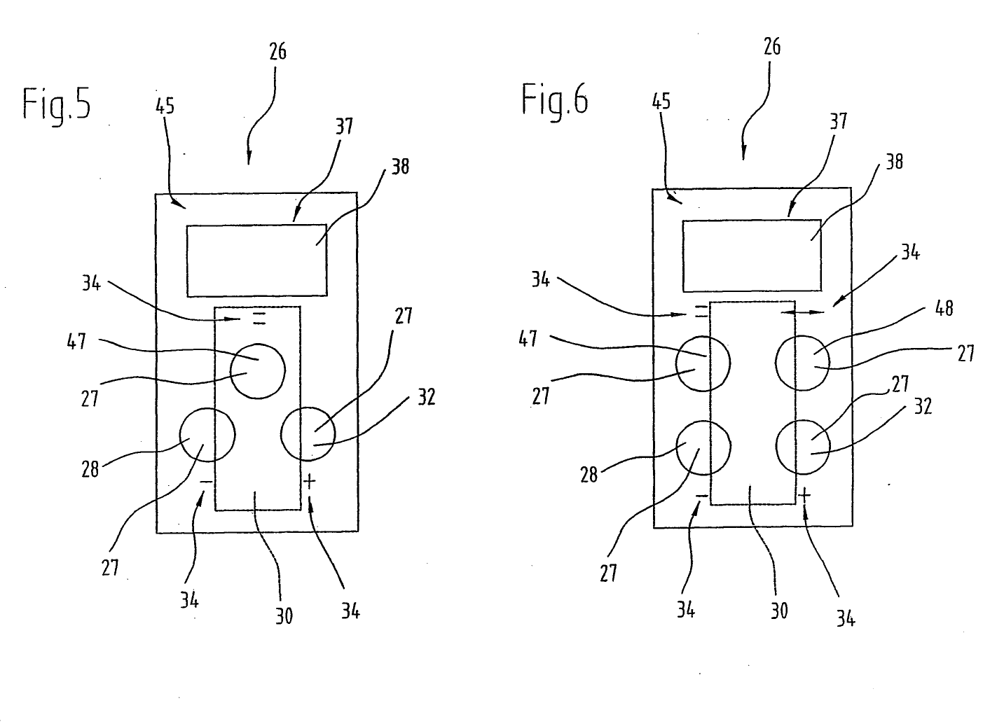

FIG. 5 shows a second embodiment variant of the remote controller in a top view;

FIG. 6 shows a third embodiment variant of the remote controller in a top view;

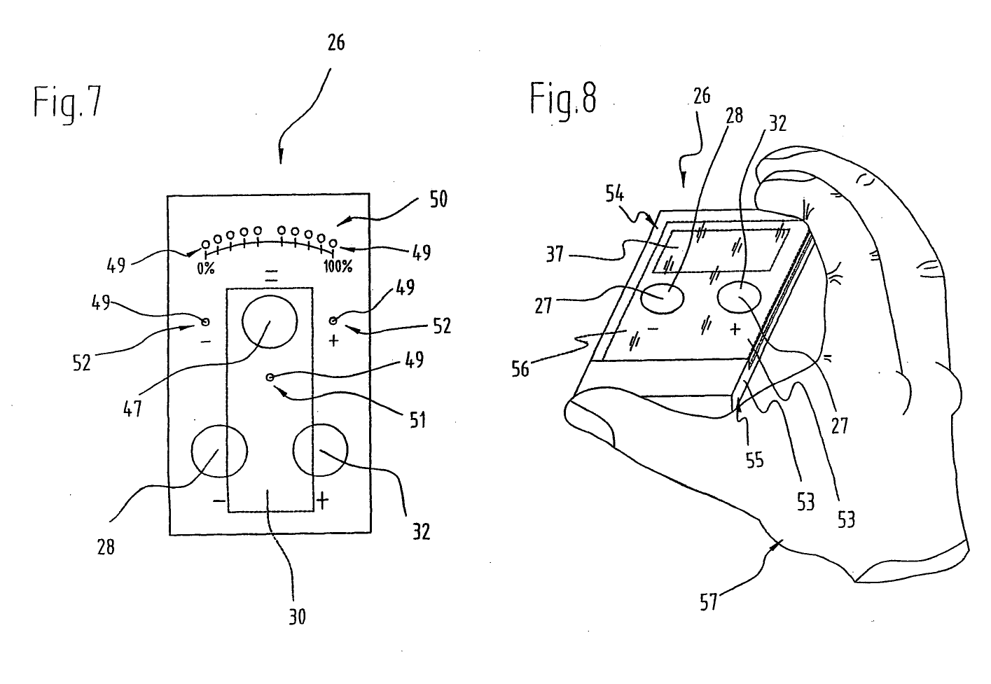

FIG. 7 shows a fourth embodiment variant of the remote controller in a top view;

FIG. 8 shows a fifth embodiment variant of the remote controller in an oblique view; and

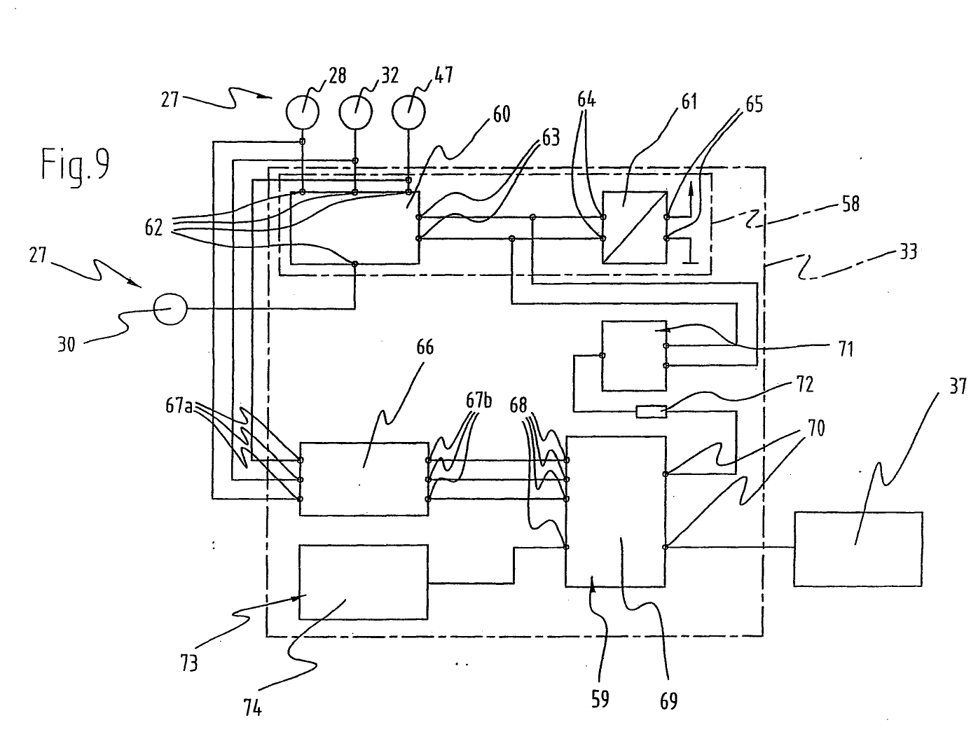

FIG. 9 shows a possible design of the inventive remote controller, illustrated as a block diagram.

In FIG. 1, a welding device 1 or a welding plant is illustrated which can be used in combination with the inventive component. Here, the welding device 1 is suited for the most different welding methods, such as, e.g. MIG/MAG welding and WIG/TIG welding or electrode welding methods, etc. The welding device 1 may in particular be designed as a hand-held welding device, e.g. for welding with bar electrodes.

The welding device 1 comprises a current source 2 with a power element 3, a control unit 4 and a switching member 5 associated to the power element 3 and/or the control unit 4. The switching member 5 and/or the control unit 4 is (are) connected with a control valve 6, which is arranged between a gas reservoir 9 and a welding torch 10 in a supply line 7 for a gas 8, in particular a protective gas, e.g. CO₂, helium or argon and the like.

Additionally, a wire feeder 11, which is usually used for MIG/MAG welding, my be activated via the control unit 4, wherein an electrode 13 and/or a welding element, e.g. a welding wire, is fed from a feed drum 14 into the region of the welding torch 10 via a supply line 12. Of course, it is possible for the wire feeder 11 to be integrated into the welding device 1, in particular into the basic housing, as is known from the prior art, instead of being designed as auxiliary device, as is shown in FIG. 1. Furthermore, there is the possibility that the welding device 1 does not comprise a wire feeder 11, as is the case, e.g., during welding with bar electrodes.

The current necessary for establishing an electric arc 15 between the electrode 13 and a workpiece 16 is supplied from the power element 3 of the welding-current source 2 to the welding torch 10 and/or the electrode 13 via a welding line 17, wherein the workpiece 16 to be welded is likewise connected with the welding device 1, in particular the current source 2, via a further welding line 18, thus allowing for an electric circuit to be established via the electric arc 15.

In order to cool the welding torch 10, the same may be connected with a liquid reservoir, in particular a water reservoir 21 via a cooling circuit 19, with a flow control 20 being superimposed, whereby the cooling circuit 19, in particular a liquid pump used for the liquid, e.g. water, provided in the liquid reservoir 21 will be started when the welding torch 10 is put into operation, thus causing a cooling of the welding torch 10 and/or the electrode 13.

Furthermore, the welding device 1 has an input and/or output device 22, via which the most different welding parameters and/or operational modes of the welding device 1 can be set. Here, the welding parameters set via the input and/or output device 22 are forwarded to the control unit 4 and, subsequently, the individual components of the welding plant or the welding device 1 will be activated by the control unit 4 and the corresponding desired values for the control will be provided by the same.

Furthermore, in the exemplary embodiment illustrated, the welding torch 10 is connected with the welding device 1 or the welding plant via a hose pack 23. The individual lines leading from the welding device 1 to the welding torch 10 are arranged in the hose pack 23. The hose pack 23 is connected with the welding torch 10 via a connection unit 24 known from the prior art, whereas the individual lines provided in the hose pack 23 are connected with the individual components of the welding device 1 via female connectors and/or plug connectors. In order to ensure an appropriate strain relief of the hose pack 23, the hose pack 23 is connected with a housing 25, in particular with the basic housing of the welding device 1, via a strain-relief means.

Basically, mention has to be made that not all above-mentioned components must be used and/or utilized for the different welding methods and/or welding devices 1, e.g. with MIG/MAG devices or hand-held devices for bar electrodes. For example, it is also possible to design the welding torch 10 as an air-cooled welding torch 10.

Furthermore, FIG. 1 shows an inventive component comprised of a remote controller 26. The remote controller 26 is provided as a discrete operation unit for a user, wherein the remote controller 26 and the control unit 4 of the welding device 1 are designed for transmitting signals and/or data in a unidirectional or bidirectional manner. The dotted lines represent that position of the welding torch 10 and/or the electrode 13 in that these components are connected with the remote controller 26 for the purpose of signal exchange such that the remote controller 26 will be activated. In order to activate the remote controller 26, the same is integrated into the electric circuit of the welding device 1 which is established via the welding lines 17, 18. In the exemplary embodiment shown, a first welding line 17 of the welding device 1 is electrically and/or galvanically connected with the remote controller 26, with the welding line 17 carrying a positive or negative potential, wherein the remote controller 26 is also connected with the further welding line 18 of the welding device 1 and the potential applying thereto. Preferably, the remote controller 26 is used with electrode or WIG and/or TIG welding devices.

A first embodiment variant of an inventive remote controller 26 can be seen from FIGS. 2 to 4. The remote controller 26 has several contact elements 27 which are designed for establishing an electric connection with the welding device 1 and/or a workpiece 16. A first contact element 27 is comprised of a first electrode contact 28, via which a first potential 29 may be applied to the remote controller 26. To this end, the electrode contact 28 is contactable by the electrode 13 of the welding device 1 so as to allow for an electrical connection to be established with the current source 2 and/or the control unit 4 of the welding device 1. Furthermore, the remote controller 26 comprises a further contact element 27 which is comprised of a workpiece contact 30, to which contact element 27 a further potential 31 may be applied. For this purpose, the workpiece contact 30 is connected with the workpiece 16 so that the workpiece contact 30 will also be connected with the current source 2 and/or the control unit 4 of the welding device 1. Here, mention shall be made of the possibility to connect the workpiece contact 30 with any conductor that carries the potential 31, rather than connecting the same with the workpiece 16. For example, the workpiece contact 30 may be connected with a ground and/or zero potential of an energy-supply structure (not further illustrated).

According to the invention, at least one further contact element 27 of the remote controller 26 is comprised by a further electrode contact 32 which may be contacted with the electrode 13, as may the first electrode contact 28, so as to connect the remote controller 26 with the current source 2 and/or the control unit 4 of the welding device 1.

Parameters of the current source 2 can be called and/or changed via the remote controller 26 which is connected with the current source 2 via the electrode contacts 28, 32. To this end, at least one of the two electrode contacts 28, 32 is designed for adjusting one or several parameter(s) of the current source 2, in particular for increasing or decreasing the absolute value of the at least one welding parameter. Preferably, at least one of the electrode contacts 28, 32 is additionally designed for querying and/or calling one or several parameter(s) of the current source 2. For example, a value may be reduced by contacting the electrode contacts 28 and the value of a welding parameter may be increased by contacting the electrode contact 32. This change of the value may now by transmitted to the control unit 4 of the welding device 1 immediately via the welding line 17 so as to allow for an online configuration of the welding device 1 via the remote controller 26. Moreover, there is the possibility to design one electrode contact 28 for displaying welding parameters and/or for affirming settings, and that the other electrode contact 32 is designed for adjustment purposes. Thus, the value of the welding parameter may be set and stored via the electrode contact 31, e.g. in a loop, wherein this setting will be transmitted to the control unit 4 of the welding device 1 only after a contacting of the first electrode contact 28 has occurred.

The remote controller 26 comprises a control unit 33 which is connected with the electrode contacts 28, 32 and the workpiece contact 30. The control unit 33 is designed for processing the incoming signals at the electrode contacts 28, 32 and/or for transmitting the signals to the control unit 4 of the welding device 1 via the electrode contacts 28, 32. Likewise, the control unit 33 is designed for using the voltage, which applies to the electrode contacts 28, 32 and/or the workpiece contact 30 and is generated by the current source 2 of the workpiece 1, for its own energy supply. Furthermore, the control unit 33 has a storage, in which the one or several welding parameters lastly set via the remote controller 26 and/or their values are stored. The exact design of the control unit 33 will be described by way of FIG. 9.

The remote controller 26 comprises a first operational state, during which the remote controller 26 is decoupled or separated from the current source 2 of the welding device 1, as is shown in FIG. 3. In the first operational state, the remote controller 26 is deactivated in a possible embodiment variant. In a further operational state, the remote controller 26 is coupled with the current source 2 of the welding device 1 via the welding lines 17, 18, whereby the remote controller 26 will be supplied with energy and will be activated and ready for use, as is shown in FIG. 4. Mention shall be made of the possibility to provide a temporary energy storage, e.g. an inductance or capacity, in the remote controller 26, which energy storage will be charged by the welding lines 17, 18 coupled to the remote controller 26 so that even when the remote controller 26 has been decoupled from the current source 2, it will be ready for use over a period of time determined by the energy storage. For example, when the remote controller 26 has been decoupled from the current source 2, the remote controller 26 may be restricted in its operation, in particular in a configuration mode or the like, during which welding parameters may be set in a manner similar to offline-mode that may be transmitted to the welding device 1 after the next connection has been established or local settings are done on the remote controller 26.

In the activated operational state of the remote controller 26, at least one of the welding parameters, e.g. a current, a voltage, a pulse width, a frequency, etc., is recognized by the control unit 33 via the signal at the electrode 13 to which an idle voltage applies before it will be put on the electrode contact 28 and/or 32, said parameter being visualizable and, if need be, changeable via the remote controller 26. Here, a design of the welding device 1 is advantageous in which the control unit 4 of the welding device 1 recognizes when a connection of the electrode 13 with the electrode contact 28 or 32 has been established, and the current source 2 optionally outputs a signal adapted to the remote controller 26 and/or a modified signal, as may be the case with known remote controllers.

In the embodiment variant shown in FIGS. 2 to 4, two electrode contacts 28, 32 are provided, via which all setting options integrated in the remote controller 26 may be done. One of the electrode contacts 28, 32 is designed for reducing the value of the welding parameter to be currently processed, and the other electrode contact 28, 32 is designed for increasing this welding parameter. In order to label the functions allocated to the individual electrode contacts 28, 32, two signs 34 are provided on the remote controller 26. By a minus symbol, the first sign 34 labels the electrode contact 28 such that its function for reducing the value of a welding parameter is recognizable by a user, whereas the other sign 34, by a plus symbol, labels the function of the electrode contact 32 for increasing a welding-parameter value. The signs 34 are provided, e.g. on or in a housing 36 of the remote controller 26, e.g., embossed, engraved, imprinted, glued thereonto or the like.

In order to visualize the value of a welding parameter on the remote controller 26, the same comprises a readout 37 which may be comprised, e.g. of a display 38. The display 38 is comprised of a prior-art device for displaying alpha-numerical information, e.g. a seven-segment display, an LCD (liquid crystal display) or the like. The readout 37 is connected with the control unit 33 of the remote controller 26 so as to allow for information and/or signals processed by the remote controller 26 to be displayed on the readout 37. Here, it is possible that the readout 37 displays the absolute value of a corresponding welding parameter and/or a relative, in particular percentual, value of the maximum value of the welding parameter.

For the case that a contact has been established between the electrode 13 and one of the electrode contacts 28, 32, the control unit 33 is designed for outputting information to the readout 37 so that the present value of a welding parameter will be displayed. For the case that only two electrode contacts 28, 32 are present, the control unit 33 comprises a means, by the aid of which the stored value of a welding parameter will be displayed and changed via the same electrode contact 28, 32, if need be. For example, this means is comprised of a delay member so that the stored value will be displayed for a predefined period of time, wherein the adjustment can be done via the electrode contact 28, 32 after the period of time has expired. Furthermore, the means may be comprised of a counter so that the stored value will be displayed after a first contacting of the electrode contact 28, 32, and that the counter will recognize this when the contact is interrupted and re-established within a certain period of time and will allow for the value to be adjusted. When a welding parameter has been adjusted, the readout 37 can immediately display the corrected value.

According to the embodiment, the workpiece contact 30 of the remote controller 26 is arranged on a rear side 39 of the remote controller 26, wherein the electrode contacts 28, 32 are provided on a front side 40 of the housing 36 opposing the rear side 39. Preferably, the housing 36 of the remote controller 26 is planar and, for example, cuboid-shaped, i.e. the width 41 and the length 42 of the housing 36 are dimensioned to be wider or longer than the thickness 43. In the exemplary embodiment shown, the readout 37 is arranged on the front side 40 of the housing 36. The housing 36 has one opening each for each of the contact elements 27. In the exemplary embodiment shown, two openings for the electrode contacts 28, 32 are provided in the housing 36 on the front side 40, and one opening for the workpiece contact 30 is arranged on the rear side 39, via which a contact surface 44 of the electrode contacts 28, 32 and of the workpiece contact 30 is accessible. Preferably, the readout 37 is arranged in the interior of the housing 36, and the housing 36 is designed to be translucent at least in a region 45 above the readout 37 so that the readout 37 will be visible from the outside and be protected by the housing 36.

Such a design of the housing 26 allows for a simple handling of the remote controller 26 since the remote controller 26 will be connected with the corresponding potential 31 by simply putting the remote controller 26, with its rear side 39, on the workpiece 16 of the workpiece contact 30 so that the user will subsequently be enabled to do all available settings on the remote controller 26 by means of the electrode 13 of the welding torch 10, without having to put the welding torch 10. To this end, a fixing element 46 may be provided on the rear side 39, via which the remote controller 26 may be detachably fixed to the workpiece 16. In the exemplary embodiment shown, the fixing element 46 is at the same time comprised of the workpiece contact 30, with the latter being designed to be magnetic. However, the remote controller 26 may also comprise separate fixing elements for connection with a workpiece 16 and/or a part, which carries the corresponding potential 31, wherein, here, connecting and/or fixing means known from the prior art may be used.

FIG. 5 shows a further embodiment variant of the remote controller 26, wherein the remote controller 26 comprises one further electrode contact 47, i.e. in total four contact elements 27 which are comprised of three electrode contacts 28, 32, 47 and the workpiece contact 30. Here, the first electrode contact 28 is designed for displaying a welding parameter to be adjusted. The two further electrode contacts 32, 47 are designed for adjusting the welding parameter, in particular for increasing and reducing the welding parameter, wherein this adjustment is effected in an already above described manner.

A further embodiment variant of the remote controller 26 is illustrated in FIG. 6, wherein the remote controller 26 comprises one further electrode contact 48, i.e. in total five contact elements 27 which are comprised of four electrode contacts 28, 32, 47, 48 and a workpiece contact 30. Here, the first electrode contact 28 is designed for displaying a welding parameter to be adjusted. The two further electrode contacts 32, 47 are designed for adjusting the welding parameter, in particular for increasing and reducing the welding parameter. The fourth electrode contact 48 is designed for selecting and/or changing different welding parameters.

According to the invention it is provided that at least one welding parameter is callable and/or changeable via the remote controller 26. In particular, in the case of a remote controller 26 for only one welding parameter, the welding current of the welding device 26 can be processed as a welding parameter by the remote controller 26. According to the exemplary embodiment of FIG. 6, several welding parameters are processable by the remote controller 26, for the purpose of which a selection of the welding parameter to be processed is possible via the fourth electrode contact 48. However, mention shall be made here that the selection of the welding parameter may also be possible in case of remote controllers 26 without a special electrode contact 48, wherein, to this end, one or several electrode contacts 28, 32; 47 may have several functions, e.g., “display parameter” and “change parameter”, between which may be switched by means of the above-described time members, contact counters or the like, preferably in a cyclic manner.

In FIG. 7, a further embodiment variant of the remote controller 26 is shown, wherein the readout 37 comprises several discrete illumination means 49, in particular LEDs. The illumination means 49 form a scale 50, via which a relative and/or proportional value of the maximum value of a welding parameter is displayable. If the present value of the welding parameter is, e.g., 50% the maximum value, half of the illumination means 49 will be in operation. To this end, the illumination means 49 are preferably successively activated from the left to the right or deactivated from the right to the left. Furthermore, there is the possibility that a value range of a welding parameter is assigned to each illumination means 49 so that only that illumination means 49 will be active, into whose illumination range the value of the welding parameter falls.

Furthermore, according to FIG. 7, a readout (displaying means) 51 is provided for displaying a contact of the contact elements 27, said readout being likewise comprised of an illumination means 49, e.g. The contact readout 51 is designed for displaying the operational state of the remote controller 26, wherein the contact display 51 will be activated when a connection has been established between the electrode 13 and an electrode contact 28; 32; 47; 48, and between the workpiece contact 30 and the workpiece 16.

Furthermore, a readout (displaying means) 52, which is in contact with the electrode 13 and displays the plus pole and minus pole, may be provided for displaying the polarity on the control element. In the exemplary embodiment shown, the polarity readout 52 is likewise comprised of two illumination means 49, wherein the one illumination means 49 is only activated in the case of positive polarity at the electrode 13 and the other illuminations means 49 only in the case of negative polarity at the electrode 13. Mention shall be made that the state information of the contact readout 51 and/or the polarity readout 52 may certainly also be present as an illumination means 49 in the case of a readout 37 designed as a display 38 or this state information may be output directly via the display 38.

In FIG. 8, an embodiment variant of the remote controller 26 with two electrode contacts 28, 32 is shown, wherein at least part of the housing 36 is translucent and/or transparent. In particular, the housing 36 has several parts 53, wherein at least one upper part 54 and at least one bottom part 55 are provided. In the exemplary embodiment, the upper part 54 is made of transparent material, in particular of plastics. The bottom part 55 may likewise be made of optionally transparent material and/or plastics, wherein there is the possibility that the bottom part 55 and/or further parts 53 are designed to be opaque and/or made of a different material, e.g. a metal alloy, in particular an aluminum-magnesium cast part or the like. The housing 36 may also consist of only one single, preferably transparent part 53, and the control unit 33 and the readout 37 may be integrated into the housing 36, e.g. molded or welded thereinto.

In the interior of the housing 36, the control unit 33 and the readout 37 may be arranged on a common board 56. The electrode contacts 28, 32; 47; 48 and the workpiece contact 30 are connected with the control unit 33 via the board 56 by means of permanent contact points, e.g. soldering joints. Thus, the remote controller 26 does not comprise any moveable parts, whereby a remote controller 26 is advantageously created which is robust and little susceptible to errors. Furthermore, the use of electric contact elements 27 as setting means in comparison with remote controllers with manually adjustable setting means, such as potentiometers known from the prior art or the like, allows for a very small size of the remote controller 26, without restricting the possible functions of the remote controller 26. As illustrated in FIG. 8, the remote controller 26 is preferably dimensioned such that it can be conveniently placed in one hand 57 of a user. To this end, the remote controller 26 has preferably roughly the size of a checkcard, e.g. a width 41 from 20 to 100 mm, in particular of from 40 to 70 mm, a length 42 of from 50 to 150 mm, in particular of from 60 to 120 mm, and a thickness 43 of from 5 to 30 mm, in particular of from 10 to 20 mm (cf. FIGS. 2 and 3). Thus, the remote controller 26 can be conveniently put into a pocket of the user's clothes, without compromising the user in their further activities.

FIG. 9 shows the block diagram of a possible embodiment variant of the remote controller 26 with three electrode contacts 28, 32, 47. The remote controller 26 contains the control unit 33, the readout 37 and the contact elements 27, in particular the electrode contacts 28, 32, 47 and the workpiece contact 30.

The contact elements 27 are connected with a voltage supply 58 that is assigned to the control means 33. The voltage supply 58 is designed for supplying a logic circuit 59 with the voltage level necessary, wherein the input voltage at the voltage supply 58 is the idle voltage at the electrode 13. In order to provide a defined voltage for the logic circuit 59, the voltage supply 58 may comprise a rectifier 60 and, if need be, a voltage converter 61. At the inputs 62, the rectifier 60 is connected with the contact elements 27. An output 63 of the rectifier 60 is optionally connected with an input 64 of the voltage converter 61. The rectifier 60 allows for the use of the remote controller 26 for welding devices 1 with alternating and/or negative polarity at the electrode 13. The voltage converter 61 connected with the output 63 of the rectifier 60 is designed for generating a voltage with a defined level at an output 65, with which the logic circuit 59 is supplied, e.g.

Furthermore, the control unit 33 has an analog-digital converter 66 which is connected with the electrode contacts 28, 32, 47, 48 at an input 67a and with inputs 68 of the logic circuit 59 at an output 67b. Here, an input 68 of the logic circuit 59 is assigned to each electrode contact 28, 32, 47, 48, whereby it can be detected via the logic circuit 59 to which electrode contact 28, 32, 47, 48 a voltage applies and which welding parameter and/or value applies. A storage is assigned to the logic circuit 59, in which welding parameters and/or their values can be stored. For this purpose, the logic circuit 59 is preferably comprised of a microcontroller 69, whereby the remote controller 26 may be controlled by means of a program logic which has been deposited in the microcontroller 69 and which is exchangeable, if need be.

An output 70 of the logic circuit 59 is connected with the electrode contacts 28, 32, 47, 48 via a switching element 71. For example, the switching element 71, optionally via an ohmic resistance 72, is connected with an output 70 of the logic circuit 59 and, furthermore, with an output 65 of the voltage converter 61 and with an output 63 of the rectifier 60. The state of the switching element 71 is controlled via the output 70 of the logic circuit 59, whereby a pulsating voltage, in particular a high-frequency voltage, can be generated at the output of the switching element 71. Thus, the coupling of the output of the switching element 71 with the electrode contacts 28, 32, 47, 48 there allows for a pulsating voltage to be applied, whose frequency being predefined by the logic circuit 59. Here, the frequency of the value and/or type of the welding parameter to be presently processed is calculated by the logic circuit 59. When the idle voltage of the electrode 13 applies, the pulsating voltage is up-modulated, wherein corresponding means for demodulating this voltage are provided in the control means 4 of the welding device 1. By this type of signal transmission, the current source 2 of the welding device 1 may be adjusted via the remote controller 26, wherein such devices and methods for signal modulation and/or superimposition with welding devices are known from the prior art, which is why they are not further dealt with in this document.

Furthermore, the readout 37 is connected with an output 70 of the logic circuit 59 so that the logic circuit 59 may perform a predefined visualization of the welding parameters.

As is illustrated in the exemplary embodiment, a safety system 73 may furthermore be assigned to the control unit 33, which safety system has a unique identification characteristic. The safety system 73 may be comprised, e.g., of a wireless transmission system, in particular a radio-transmission system 74, e.g. an RFID system (radio frequency identification) with a transponder, which safety system can receive signals from a transmitting/receiving device and/or control unit 4 of the welding device 1 and/or can transmit signals thereto. Thus, the remote controller 26 may be provided with a key function, allowing for a wireless blocking or deblocking of the welding device 1. Since RFID systems are known from the prior art, their design will not be discussed in detail.

Furthermore, there is the possibility that different presettings and/or parametrized groups of welding-parameter settings belonging together, so-called jobs, are configurable in the storage of the control unit 33 and deposited in a non-volatile storage. Thus, the jobs can be selected, whereby a job can be quickly reused after a one-time configuration. Furthermore, there may be the possibility of creating user profiles on the remote controller 26 and/or to do the setup via the remote controller 26. It is already known from prior-art adjustment means for welding devices to select a job, to provide the possibility of managing user profiles or to do a setup, as is possible with the inventive remote controller 26, which is why this issue is not dealt with in detail in this document either.

Furthermore, it is possible that when a welding device is used with an auxiliary voltage source, the supply and the communication with the remote controller is effected via the auxiliary voltage source, i.e. the power element of the welding device remains deactivated and only this auxiliary voltage source is activated.

The individual embodiment illustrated in FIGS. 1 to 9 may constitute the subject matter of discrete inventive solutions. The respective inventive objects and solutions are to be gathered from the detailed descriptions of the Figures.

1. A remote controller (26) for a welding device (1) with a housing (36), a control unit (33) and several contact elements (27) connected with the control unit (33), wherein one contact element (27) is comprised of a workpiece contact (30) for establishing a connection with a workpiece (16), and wherein at least two further contact elements (27) are comprised of electrode contacts (28) for establishing a connection with an electrode (13) of the welding device (1), wherein the one electrode contact (28) is designed for increasing the value of a welding parameter and the second electrode contact (32) is designed for reducing the same, the value of the welding parameter thus being changeable by contacting the electrode contacts (28, 32) with the electrode (13) of the welding device (1), and wherein a voltage supply (58) is effected by the welding device (1) via the contact elements (27), and wherein the control unit (33) is connected with a readout (37) designed for visualization of the value and/or type of the welding parameter to be changed, wherein it comprises a delay member, whereby the stored value of a welding parameter will be displayed over a predefined period of time when the electrode (13) contacts one of the contact elements (27), wherein the value of the welding parameter will be adjustable after the period has expired.

2. The remote controller (26) according to claim 1, wherein the control unit (33) has a storage, in which at least the welding parameter which has lastly been adjusted or called via one of the at least two electrode contacts (28, 32) is deposited.

3. The remote controller (26) according to claim 1, wherein control unit (33) is designed for outputting a signal which has been detected as a function of the value of a welding parameter, and that the signal is applied to at least one contact element (27) for the electrode (13).

4. The remote controller (26) according to claim 1, wherein the readout (37) is designed for illustrating a proportional, in particular percentual, value of a welding parameter.

5. The remote controller (26) according to claim 1, wherein the readout (37) is comprised of a display (38) or a scale(50)—forming illumination means (49), in particular LEDs.

6. The remote controller (26) according to claim 1, wherein the control unit (33) is connected with a readout (51) for displaying a present contact of the contact element (27) with the electrode (13) and the workpiece (16).

7. The remote controller (26) according to claim 1, wherein the control unit (33) is connected with a readout (52) for displaying the polarity prevailing at the contact element (27) connected with the electrode (13).

8. The remote controller (26) according to claim 1, wherein the control unit (33) comprises a voltage supply (58), in particular a power electronics for voltage conversion of the idle voltage of the welding device (1) into an appropriate voltage for supplying the components of the control unit (33).

9. The remote controller (26) according to claim 1, wherein the control unit (33) comprises a logic circuit (59), in particular a microcontroller (69).

10. The remote controller (26) according to claim 1, wherein the control unit (33) comprises a switching element (71) for generating a preferably high-frequency modulation signal for coupling into the idle voltage of the electrode (13).

11. The remote controller (26) according to claim 10, wherein the switching element (71), at one control input, is connected with an output (70) of the logic circuit (59) and is furthermore connected with the voltage supply (58), and that one output of the switching element (71) is coupled with at least one contact element (27).

12. (canceled)

13. The remote controller (26) according to claim 1, wherein the workpiece contact (30) is arranged for contacting a workpiece (16) at the rear side (39) of the housing (36), and that the workpiece contact (30) is preferably designed to be magnetic.

14. The remote controller (26) according to claim 1, wherein the housing (36) is designed in a substantially checkcard-type manner.

15. The remote controller (26) according to claim 14, wherein the housing (36) has a width (41) of from 20 to 100 mm, in particular of from 40 to 70 mm, a length (42) of from 50 to 150 mm, in particular of from 60 to 120 mm, and a thickness (43) of from 5 to 30 mm, in particular of from 10 to 20 mm.

16. The remote controller (26) according to claim 1, wherein the housing (36) is designed to be at least partially transparent.

17. The remote controller (26) according to claim 1, wherein the control unit (33), and optionally the readouts (37, 51, 52) are integrated, and in particular molded, into the housing (36), and that only the contact surfaces (44) of the contact elements (27) are accessible from the outside.

18. The remote controller (26) according to claim 1, wherein a further contact element (27) is comprised of a third electrode contact (47), wherein the first electrode contact (28) is designed for displaying the value and/or the type of a welding parameter to be adjusted, whereas the two further electrode contacts (32, 47) are designed for adjusting the value of the welding parameter, in particular for increasing and/or reducing the value of the welding parameter.

19. The remote controller (26) according to claim 1, wherein at least one further contact element (27) is comprised of an electrode contact (48) which is designed for selecting a welding parameter.

20. The remote controller (26) according to claim 1, wherein the control unit (33) has a safety system (73) for blocking or deblocking the welding device (1) in a preferably wireless manner.

21. The remote controller (26) according to claim 20, wherein the safety system (73) is comprised of a radio-transmission system (74), in particular an RFID system.
